(19) United States
(12) Patent Application Publication
(10) Pub. No.: US 2026/0027883 A1
(43) Pub. Date: Jan. 29, 2026

(54) VEHICLE BOTTOM STRUCTURE

(71) Applicant: Toyota Jidosha Kabushiki Kaisha, Toyota-shi (JP)

(72) Inventors: Katsunori HIGASHIHARA, Toyota-shi, Aichi-ken (JP); Yuuji MIZUTANI, Toyota-shi (JP)

(73) Assignee: Toyota Jidosha Kabushiki Kaisha, Toyota-shi (JP)

(21) Appl. No.: 19/074,844

(22) Filed: Mar. 10, 2025

(30) Foreign Application Priority Data
Jul. 23, 2024 (JP) 2024-117845

(51) Int. Cl. B60K 1/04; B62D 27/02; H01M 50/249

(52) U.S. Cl. CPC B60K 1/04; B62D 27/026; B60K 2001/0438; H01M 50/249; H01M 2220/20

(57) ABSTRACT

The protective panel is made of metal. The protective panel includes a panel portion and a panel reinforcing member. The panel portion has a flat plate shape. The panel reinforcing member protrudes from the panel portion. Further, the panel reinforcing member extends linearly. The panel reinforcing member has a hollow structure. Further, the panel portion and the panel reinforcing member are integrally formed.

### CROSS-REFERENCE TO RELATED APPLICATION

This application claims priority to Japanese Patent Application No. 2024-117845 filed on Jul. 23, 2024. The disclosure of the above-identified application, including the specification, drawings, and claims, is incorporated by reference herein in its entirety.

### BACKGROUND

### 1. Technical Field

The present specification discloses a vehicle bottom structure.

### 2. Description of Related Art

A battery pack is installed in a battery electric vehicle (BEV). For example, the battery pack is disposed under a floor of a vehicle cabin.

In Japanese Unexamined Patent Application Publication No. 2023-46945 (JP 2023-46945 A), for example, a protective panel that is called a shared panel is provided downward from a battery pack. The protective panel is a panel material that is made of metal, unlike an under panel that is made of resin.

A vehicle may run up on a curb, for example. Also, the vehicle may travel over uneven road surfaces. There are cases in which the vehicle “scrapes underside”, so to say, in such instances. That is to say, a vehicle bottom face and the road surface may come into contact. At this time, a load is input from the road surface to the protective panel that is provided on the vehicle bottom face.

### SUMMARY

In order to strengthen rigidity of the protective panel, attaching a reinforcing member to the protective panel is conceivable. Also, a fastener such as a bolt or the like is used to attach the reinforcing member to the protective panel. Adding the reinforcing member and the fastener may increase weight of the protective panel undesirably.

Accordingly, the present specification discloses a vehicle bottom structure that is capable of improving rigidity of a protective panel, while suppressing increase in weight.

The present specification discloses a vehicle bottom structure. In the vehicle bottom structure, a battery pack is disposed at a vehicle bottom.
A protective panel is disposed downward from the battery pack. The protective panel covers the battery pack.
The protective panel is made of metal.
Also, the protective panel includes a panel portion and a panel reinforcing member.
The panel portion is shaped as a plate.
The panel reinforcing member protrudes from the panel portion. Also, the panel reinforcing member extends linearly.
The panel reinforcing member is a hollow structure.
Further, the panel portion and the panel reinforcing member are integrally fashioned.

According to the above configuration, the panel portion and the panel reinforcing member are integrally fashioned, and accordingly, weight increase due to the fastener is circumvented. Further, the panel reinforcing member has a hollow structure, and accordingly increase in weight is suppressed, as compared with a case in which a solid material is used.

Also, in the above configuration, a flange portion that is fastened to the battery pack may be provided at both ends of the panel portion in a vehicle width direction. In this case, a stepped structure is shaped by the panel portion and the flange portion. Due to this stepped structure, the flange portion is disposed upward from the panel portion.
The panel reinforcing member protrudes upward from the panel portion.
An adhesive is further disposed on an upper end of the panel reinforcing member.
A height of protrusion of the panel reinforcing member is no less than a height of a step of the stepped structure.

According to the above configuration, the upper end of the panel reinforcing member can be bonded to a bottom face of the battery pack by causing the panel reinforcing member to protrude beyond the stepped structure.

Also, in the above configuration, the panel reinforcing member may extend in a vehicle front-rear direction.
The battery pack includes a plurality of battery cells and a battery case.
The battery case accommodates the battery cells.
The battery case includes a tray portion in which the battery cells are disposed.
A case reinforcing member is disposed on a bottom wall of the tray portion.
The case reinforcing member extends in the vehicle front-rear direction.
The upper end of the panel reinforcing member is bonded to the bottom wall of the tray portion.
The panel reinforcing member and the case reinforcing member are disposed on a straight line in a vehicle height direction.

According to the above configuration, the case reinforcing member is disposed directly above the panel reinforcing member. Accordingly, both the panel reinforcing member and the case reinforcing member are integrally subjected to loads from the road surface.

Also, in the above configuration, the panel reinforcing member protrudes upward from the panel portion.
A fastening hole may be bored in the panel reinforcing member, in a thickness direction of the panel reinforcing member.
A service hole is bored in the panel portion. The service hole is concentric with the fastening hole. Also, the service hole is larger than a diameter of a head of a fastener.

According to the above configuration, the head of the fastener is suppressed from protruding from the protective panel. As a result, deterioration of aerodynamic characteristics of the vehicle is suppressed.

Also, in the above configuration, a plurality of the panel reinforcing member may be shaped at intervals on the protective panel.

In this case, a separation distance between the panel reinforcing members that are adjacent may be smaller than a width of the panel reinforcing members.

According to the above configuration, an area that is covered by the panel reinforcing member is broader than an area that is not covered.

According to the vehicle bottom structure disclosed in the present specification, rigidity of the protective panel can be improved while suppressing increase in weight.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view illustrating a vehicle bottom structure according to the present embodiment;

FIG. 2 is a perspective view of a protective panel;

FIG. 3 is a cross-sectional III-III view of FIG. 1;

FIG. 4 is a III-III cross-sectional view of a first alternative vehicle bottom structure; and

FIG. 5 is a perspective view showing a first alternative example of the protective panel.

### DETAILED DESCRIPTION OF EMBODIMENTS

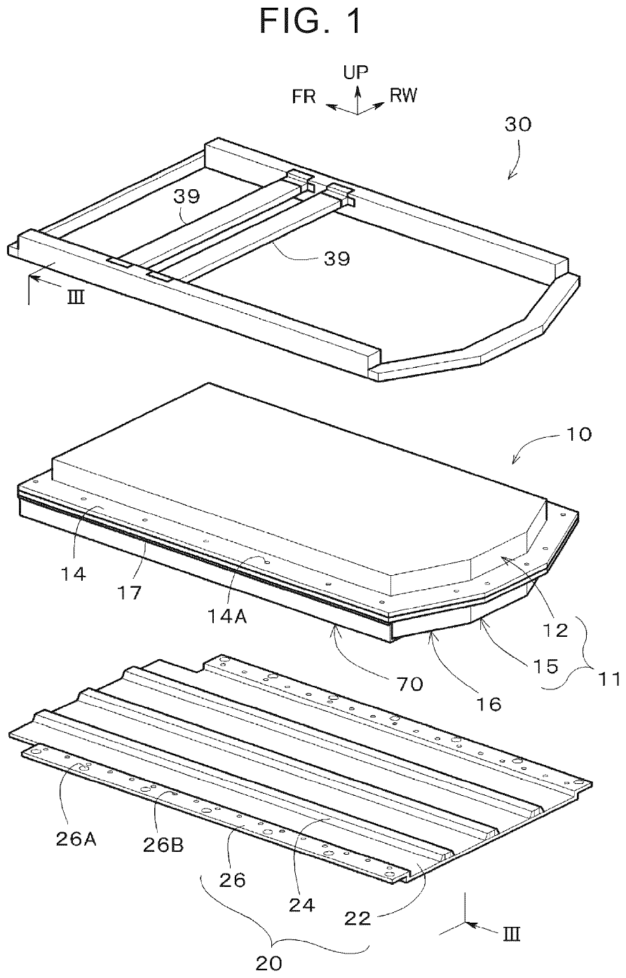

FIG. 1 to FIG. 5 illustrate a vehicle bottom structure according to the present embodiment. In FIG. 1 to FIG. 5, the vehicle front-rear directions of vehicles are indicated by FR shafts. The vehicle width direction is indicated by RW shaft. The vertical is indicated by UP axis. FR shaft has a forward direction. RW shaft shall be rightward in the positive direction. The height direction of UP shaft is the positive direction.

### 1. Overall Configuration

FIG. 1 illustrates an exploded perspective view of a vehicle bottom structure. The vehicle bottom structure according to the present embodiment is mounted on a battery electric vehicle (BEV). The vehicle bottom structure according to the present embodiment includes a battery pack 10, a protective panel 20, and a frame 30.

A battery pack 10 is disposed at the vehicle bottom. Further, a protective panel 20 is disposed below the battery pack 10. That is, the lower portion of the battery pack 10 is covered with the protective panel 20. The battery pack 10 and the protective panel 20 are supported by the frame 30.

The protective panel 20 protects the battery pack 10 from uneven road surfaces, curbstones, and the like. The protective panel 20 is made of metal. For example, as described below, the protective panel 20 is made of aluminum.

In order to improve the rigidity of the protective panel 20, the protective panel 20 is provided with a panel reinforcing member 24. The panel reinforcing member 24 has a hollow structure. Therefore, the weight increase of the protective panel is suppressed as compared with the case where the panel reinforcing member 24 is a solid material. Further, the panel reinforcing member 24 is integrally formed with the panel portion 22. That is, a fastener for attaching the panel reinforcing member 24 to the panel portion 22 is not required. This also suppresses the weight increase of the protective panel.

### 2. Frame

The frame 30 is a frame-shaped frame member. For example, the frame 30 supports the entire circumference of the battery pack 10. For example, the frame 30 and the battery pack 10 constitute a floor surface of the vehicle cabin. Further, a seat bracket 39 is coupled to the frame 30.

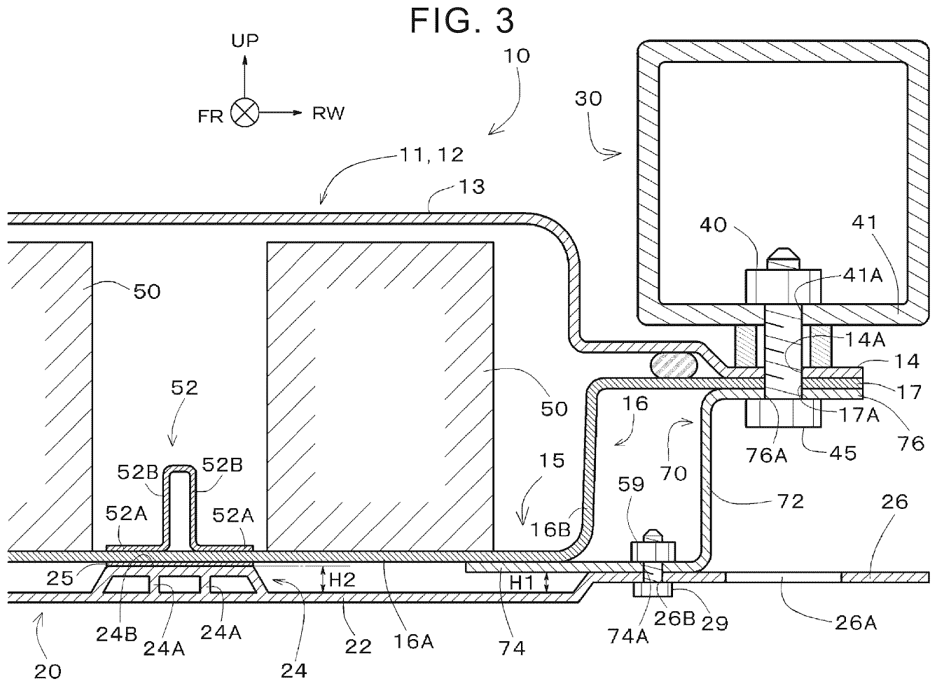

Referring to FIG. 3, the frame 30 comprises, for example, a hollow structure. For example, the cross section of the frame 30 is rectangular. A fastening hole 41A is bored in the bottom wall 41 of the frame 30. The fastening hole 41A penetrates the bottom wall 41 in the thickness direction.

A weld nut 40 is provided inside the frame 30. The weld nut 40 is coaxial with the fastening hole 41A. As will be described later, the fastening hole 14A, 17A of the battery pack 10 is aligned with the fastening hole 41A. Further, the fastening hole 76A of the case bracket 70 is also aligned with the fastening hole 41A. Bolts 45 (fasteners) are screwed into these fastening holes 14A, 17A, 41A, 76A. Accordingly, the battery pack 10 and the protective panel 20 are fastened to the frame 30.

### 3. Battery Pack

Referring to FIG. 1, the battery pack 10 is a box-shaped large component. For example, the battery pack 10 is disposed on the floor of the vehicle cabin. The battery pack 10 supplies electric power to a rotary electric machine (not shown) which is a driving source of the vehicle.

The battery pack 10 is supported by the frame 30. Referring to FIGS. 1 and 3, a plurality of fastening hole 14A, 17A are bored in the upper flange 14 and the lower flange 17 of the battery pack 10, for example. The upper flange 14 and the lower flange 17 are formed over the entire circumference of the battery pack 10. The fastening hole 14A, 17A is formed over the entire circumference of the upper flange 14 and the lower flange 17. Therefore, the battery pack 10 is fastened and supported to the frame 30 over the entire circumference.

Referring to FIG. 3, the battery pack 10 includes a battery case 11 and a plurality of battery cells 50. The battery case 11 accommodates the battery cells 50. The battery cell 50 includes, for example, a nickel-hydrogen secondary battery, a lithium-ion secondary battery, and an all-solid-state battery.

Referring to FIGS. 1 and 3, the battery case 11 includes an upper case 12 and a lower case 15. The lower case 15 includes a tray portion 16 and a lower flange 17. The lower case 15 is made of a metal panel such as an aluminum panel. For example, the lower case 15 is formed by press working. A plurality of battery cells 50 are arranged in the tray portion 16.

The lower flange 17 is disposed at the periphery of the tray portion 16. For example, the lower flange 17 surrounds the tray portion 16 over the entire circumference. The lower flange 17 is provided at an upper end portion of the tray portion 16.

The upper case 12 is a lid portion of the battery case 11. For example, the upper case 12 is formed of a metal panel such as an aluminum panel. For example, the upper case 12 is formed by press working.

The upper case 12 includes a cover portion 13 and an upper flange 14. The cover portion 13 is placed on the tray portion 16 of the lower case 15. An upper flange 14 is disposed on a peripheral edge of the cover portion 13. For example, an upper flange 14 is provided at a lower end of the cover portion 13. The upper flange 14 is provided over the entire circumference of the cover portion 13.

Further, referring to FIG. 1, the case bracket 70 is attached to the outer surface (exposed surface) of the lower case 15. For example, the case bracket 70 is disposed over the entire length of the side surface of the lower case 15.

Referring to FIG. 3, the case bracket 70 has an S-shaped cross section. The case bracket 70 includes flanges 74 and 76 and a vertical plate 72. A relatively lower flange 74 and a relatively upper flange 76 are connected to the vertical plate 72.

The flanges 74 are coupled to the bottom wall 16A of the tray portion 16. For example, the flanges 74 are welded to the bottom wall 16A. A fastening hole 76A is bored in the flanges 76. The fastening hole 76A is arranged so as to be coaxial with the fastening hole 17A of the lower flange 17.

A gap along the vehicle width direction is formed between the side wall 16B of the tray portion 16 and the vertical plate 72 of the case bracket 70. A weld nut 59 is disposed in the gap. A fastening hole 74A is bored in the flange 74. The weld nut 59 is disposed so as to be coaxial with the fastening hole 74A. As described below, the weld nut 59 is a fastener for the protective panel 20. That is, the protective panel 20 is fastened to the frame 30 via the case bracket 70.

In addition to the battery cells 50, a case reinforcing member 52 is accommodated in the battery case 11. The case reinforcing member 52 has, for example, a hat-shaped cross section. The case reinforcing member 52 extends in the vehicle front-rear direction in the tray portion 16. The case reinforcing member 52 includes a pair of flange 52A, 52A and a pair of rib 52B, 52B.

The pair of flange 52A, 52A are attached to the bottom wall 16A of the tray portion 16. For example, the flange 52A, 52A is welded to the bottom wall 16A. The rib 52B is erected relative to the flange 52A.

As will be described later, the case reinforcing member 52 is disposed on a straight line along the vehicle height direction with the panel reinforcing member 24 of the protective panel 20. Further, the upper end face 24B of the panel reinforcing member 24 is brought into contact with the bottom wall 16A of the tray portion 16 via the adhesive 25. Therefore, the case reinforcing member 52 and the panel reinforcing member 24 of the protective panel 20 are integrated. For example, when a load is input upward from the road surface, the load is received by both the case reinforcing member 52 and the panel reinforcing member 24 of the protective panel 20. As described above, the load resistance is improved as compared with the case where the reinforcing member is a single body.

### 4. Protective Panel

Referring to FIG. 1, the protective panel 20 is disposed below the battery pack 10. That is, the protective panel 20 covers the battery pack 10 from below. The protective panel 20 is also referred to as a share panel.

The protective panel 20 has two functions: protection of the battery pack 10 and improvement of aerodynamic characteristics of the vehicle. In order to improve the aerodynamic characteristics of the vehicle, an undercover may be provided at the vehicle bottom. Since the undercover basically does not require rigidity, the undercover is made of a resin material. In contrast, the protective panel 20 is required to have a certain rigidity in order to protect the battery pack 10. Therefore, the protective panel 20 is made of a metal material. For example, the protective panel 20 is made of aluminum.

The protective panel 20 includes a panel portion 22, a panel reinforcing member 24, and a flange portion 26. The panel portion 22 is a flat plate-shaped member. The flange portion 26 is formed at both ends of the panel portion 22 in the vehicle width direction. The flange portion 26 is fastened to the battery pack 10 via the case bracket 70. For example, the panel portion 22 and the flange portion 26 are formed by pressing a flat plate of aluminum. Alternatively, as will be described later, the panel portion 22 and the flange portion 26 are integrally formed by aluminum extrusion.

The panel portion 22 and the flange portion 26 have a stepped structure. Referring to FIG. 3, the flange portion 26 is disposed above the panel portion 22. When the flange portion 26 is fastened to the case bracket 70, the panel portion 22 is separated from the bottom wall 16A of the tray portion 16 due to such a stepped structure. When the load from the road surface is input to the panel portion 22, the panel portion 22 may be deformed. Even in such cases, since the panel portion 22 and the bottom wall 16A are separated from each other, deformation of the bottom wall 16A following the panel portion 22 is suppressed.

A service hole 26A and a fastening hole 26B are bored in the flange portion 26. Referring to FIG. 3, the service hole 26A is disposed directly below the bolt 45. Via the service hole 26A, the bolts 45 can be removed. That is, the battery pack 10 can be removed from the frame 30 with the protective panel 20 fastened to the battery pack 10.

The fastening hole 74A of the case bracket 70 and the weld nut 59 and the fastening hole 26B are aligned with each other. When the bolts 29 are screwed into the fastening holes 26B, the fastening holes 74A, and the weld nut 59, the protective panels 20 are fastened to the case brackets 70. That is, the protective panel 20 is fastened to the battery pack 10 via the case bracket 70.

Referring to FIG. 1, the protective panel 20 is provided with a panel reinforcing member 24. The panel reinforcing member 24 protrudes from the panel portion 22. That is, the panel reinforcing member 24 protrudes upward from the panel portion 22. For example, the panel reinforcing member 24 is installed on the upper surface of the panel portion 22. The upper surface of the panel portion 22 faces the bottom wall 16A (see FIG. 3) of the battery pack 10.

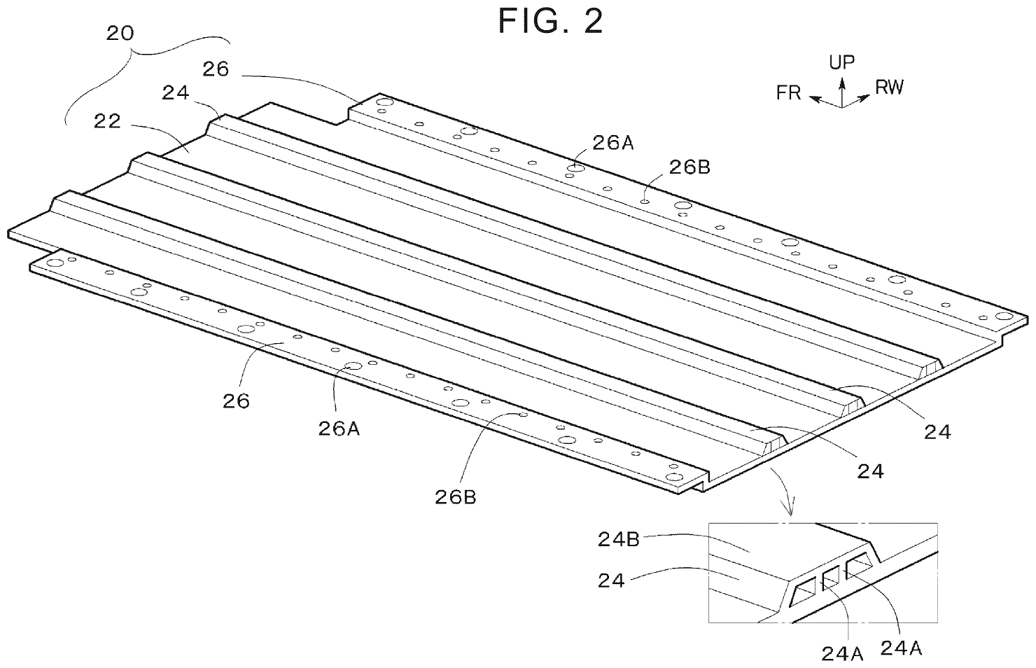

Referring to FIG. 2, the panel reinforcing member 24 extends linearly. For example, the panel reinforcing member 24 extends in the vehicle front-rear direction. For example, the panel reinforcing member 24 extends from the front end to the rear end of the panel portion 22. Further, a plurality of panel reinforcing members 24 are provided on the protective panel 20 at intervals in the vehicle width direction.

Although the panel reinforcing member 24 is extended in the vehicle front-rear direction in FIG. 2, the panel reinforcing member 24 may take other forms. For example, the panel reinforcing member 24 may extend linearly along the vehicle width direction. In this case, a plurality of panel reinforcing members 24 are provided on the protective panel 20 at intervals in the vehicle front-rear direction.

The panel reinforcing member 24 has a hollow structure. For example, in the lower right of FIG. 2, an enlarged view of the panel reinforcing member 24 is illustrated. The panel reinforcing member 24 has a trapezoidal cylindrical shape in a front view. Further, the panel reinforcing member 24 is provided with a ribbed 24A extending in the vehicle height direction. For example, a plurality of ribbed 24A is provided on the panel reinforcing member 24.

The panel reinforcing member 24 and the panel portion 22 are integrally formed. For example, the panel reinforcing member 24 and the panel portion 22 are integrally formed by aluminum extrusion. Alternatively, the panel reinforcing member 24 and the panel portion 22 are integrally formed by die casting.

In order to enable the metal material to be integrally molded, the panel reinforcing member 24 is opened at the front end and the rear end. That is, the panel reinforcing member 24 includes a die opening. The panel reinforcing member 24 extends linearly. For example, in the aluminum extrusion process, the longitudinal direction of the panel reinforcing member 24 is the extrusion direction. Further, by providing a stepped structure in the mold, the panel portion 22 and the flange portion 26 can be integrally molded. That is, the protective panel 20 is formed by integrally molding the panel portion 22, the panel reinforcing member 24, and the flange portion 26.

Referring to FIGS. 2 and 3, the upper end face 24B of the panel reinforcing member 24 is a flat surface. For example, the upper end face 24B is parallel to the panel portion 22. The adhesive 25 is disposed on the upper end face 24B. For example, a double-sided adhesive strip is adhered to the upper end face 24B.

Here, the protruding height H2 from the panel portion 22 to the upper end face 24B is equal to or greater than the step height H1 between the panel portion 22 and the flange portion 26. Therefore, when the flange portion 26 is fastened to the flange 74 of the case bracket 70, the adhesive 25 on the upper end face 24B can adhere to the bottom wall 16A of the tray portion 16. That is, the upper end face 24B of the panel reinforcing member 24 adheres to and abuts on the bottom wall 16A of the tray portion 16 via the adhesive 25.

Further, when the flange portion 26 is fastened to the flange 74 of the case bracket 70, the case reinforcing member 52 and the panel reinforcing member 24 of the battery case 11 are arranged on a straight line along the vehicle height direction. In addition, as described above, the upper end face 24B of the panel reinforcing member 24 abuts against the bottom wall 16A of the tray portion 16. That is, the case reinforcing member 52 and the panel reinforcing member 24 are integrated.

For example, when a load is input from the road surface to the panel reinforcing member 24, both the case reinforcing member 52 and the panel reinforcing member 24 receive the load. As compared with the case where the reinforcing member is a single body, the load resistance of the battery pack 10 is improved.

### 5. First Alternative of the Vehicle Bottom Structure

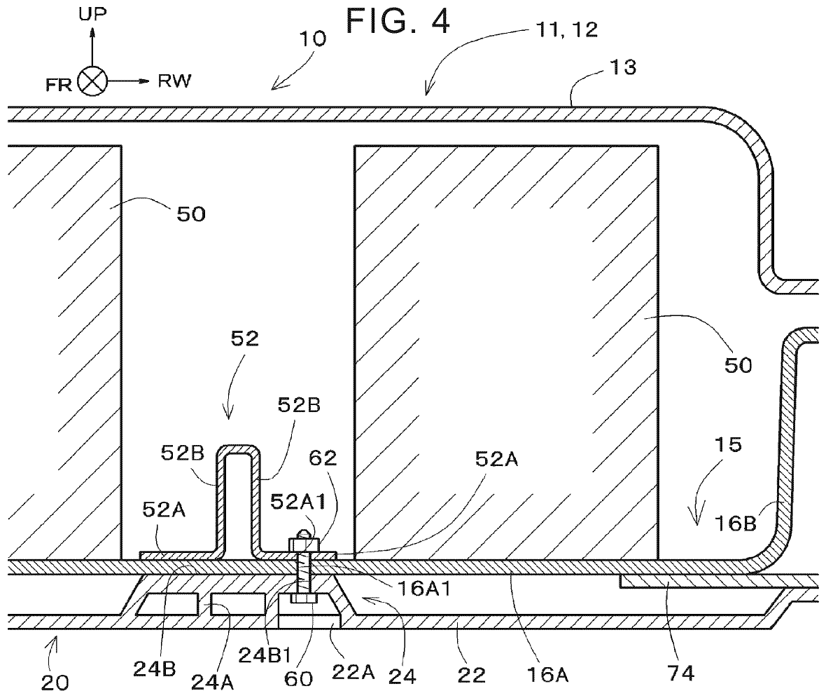

FIG. 4 shows a first alternative example of a vehicle bottom structure. In this embodiment, the abutment of the panel reinforcing member 24 on the bottom wall 16A differs from the above-described configuration. The other structures are the same as those in FIGS. 1 to 3, and thus description thereof will be omitted.

In the example of FIG. 4, instead of the adhesive 25, the panel reinforcing member 24 is fastened. In the upper end face 24B, a fastening hole 24B1 is bored in the thickness direction. In addition, a fastening hole 16A1 is bored in the bottom wall 16A of the tray portion 16. Furthermore, a fastening hole 52A1 is also bored in the flange 52A of the case reinforcing member 52. The flange 52A is also provided with a weld nut 62. The weld nut 62 is coaxial with the fastening hole 52A1.

When the protective panels 20 are fastened to the case brackets 70, the fastening holes 24B1, 16A1, 52A1 are coaxially aligned. In this condition, the bolt 60 is screwed into the fastening hole 24B1, 16A1, 52A1 and the weld nut 62. Consequently, the panel reinforcing member 24 comes into contact with the bottom wall 16A of the tray portion 16.

Here, a service hole 22A is bored in the panel portion 22. The service hole 22A is coaxial with the fastening hole 24B1 of the panel reinforcing member 24. Also, the diameter of the service hole 22A exceeds the diameter of the head of the bolt 60 (fastener).

The boring of the service hole 22A allows the head of the bolt 60 to be accommodated in the panel reinforcing member 24. In other words, the head portion of the bolt 60 is prevented from protruding downward from the panel portion 22. As a result, deterioration in aerodynamic characteristics due to bolting is suppressed.

### 6. First Example of a Protective Panel

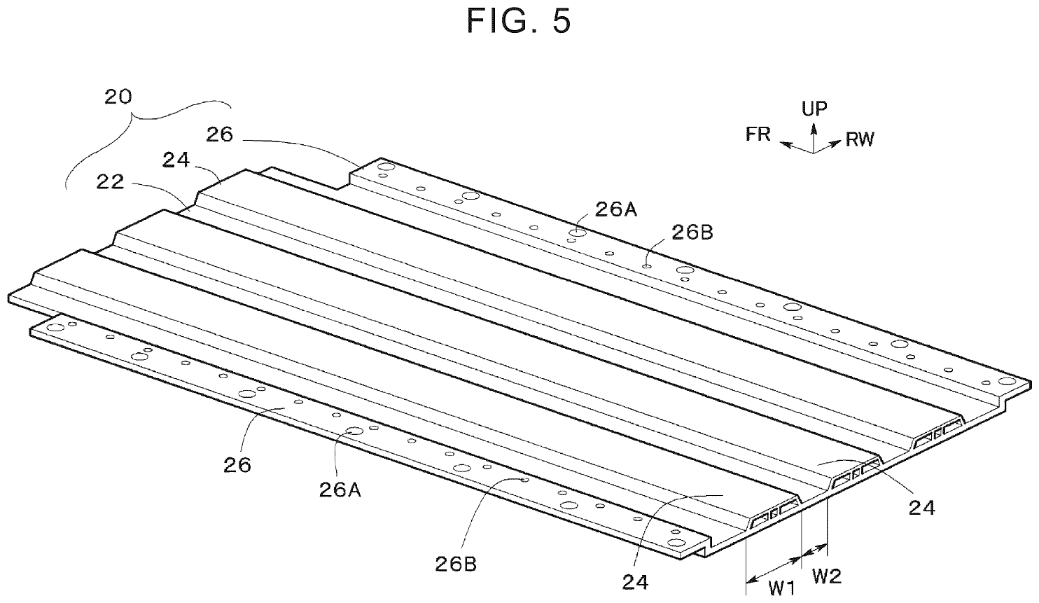

FIG. 5 shows a first alternative of the protective panel 20. In this embodiment, the width W1 and the pitch W2 of the panel reinforcing member 24 differ from those described above. The other structures are the same as those in FIG. 2, and thus description thereof will be omitted.

A plurality of panel reinforcing members 24 are arranged on the panel portion 22 at intervals along the vehicle width direction. Here, the pitch W2 of the panel reinforcing member 24 is less than the width W1 of the panel reinforcing member 24. The pitch W2 indicates the separation between adjacent panel reinforcing members 24, 24. The width W1 indicates the vehicle width direction dimension of the panel reinforcing member 24.

With such a structure, the ratio of the panel portion 22 covered by the panel reinforcing member 24 exceeds 50%. That is, the area covered by the panel reinforcing member 24 is wider than the area not covered. As a result, the rigidity of the protective panel 20 is improved.

What is claimed is:

1. A vehicle bottom structure, in which a battery pack is disposed at a vehicle bottom, wherein:
a protective panel that covers the battery pack is disposed downward from the battery pack;
the protective panel is made of metal, and includes a panel portion that is shaped as a plate, and a panel reinforcing member that protrudes from the panel portion and extends linearly;
the panel reinforcing member is a hollow structure; and
the panel portion and the panel reinforcing member are integrally fashioned.

2. The vehicle bottom structure according to claim 1, wherein:
a flange portion that is fastened to the battery pack is provided at both ends of the panel portion in a vehicle width direction;
a stepped structure is shaped by the panel portion and the flange portion, the flange portion is disposed upward from the panel portion;
the panel reinforcing member protrudes upward from the panel portion;
an adhesive is further disposed on an upper end of the panel reinforcing member; and
a height of protrusion of the panel reinforcing member is no less than a height of a step of the stepped structure.

3. The vehicle bottom structure according to claim 2, wherein:
the panel reinforcing member extends in a vehicle front-rear direction;
the battery pack includes a plurality of battery cells, and a battery case for accommodating the battery cells;
the battery case includes a tray portion in which the battery cells are disposed;
a case reinforcing member extending in the vehicle front-rear direction is disposed on a bottom wall of the tray portion;
the upper end of the panel reinforcing member is bonded to the bottom wall of the tray portion; and
the panel reinforcing member and the case reinforcing member are disposed on a straight line in a vehicle height direction.

4. The vehicle bottom structure according to claim 1, wherein:
the panel reinforcing member protrudes upward from the panel portion;
a fastening hole is bored in the panel reinforcing member, in a thickness direction of the panel reinforcing member; and
a service hole that is concentric with the fastening hole, and that is larger than a diameter of a head of a fastener, is bored in the panel portion.

5. The vehicle bottom structure according to claim 1, wherein:
a plurality of the panel reinforcing member is shaped at intervals on the protective panel; and
a separation distance between the panel reinforcing members that are adjacent is smaller than a width of the panel reinforcing members.
